(19) United States
(12) Patent Application Publication
(10) Pub. No.: US 2007/0276873 A1
(43) Pub. Date: Nov. 29, 2007

(54) System and method for optimizing efficiency of replicated network services

(76) Inventors: Amin M. Vahdat, Bahama, NC (US); Haifeng Yu, Shanghai (CN)

Correspondence Address: THE FLESHNER GROUP, PLLC, P.O. BOX 1397, ASHBURN, VA, 20146-9998, US

(21) Appl. No.: 10/547,927

(22) PCT Filed: Feb. 13, 2002
(86) PCT No.: PCT/US02/04172

§ 371 Date: Jan. 22, 2007

Related U.S. Application Data
(60) Provisional application No. 60/268,046, filed on Feb. 13, 2001.

(51) Int. Cl. G06F 17/00

(52) U.S. Cl. 707/200

(57) ABSTRACT

A system and method for controlling a selectable level of consistency in a replicated data system (FIG. 3) uses consistency metrics to determine when to perform updates between data replicas. Each replica tracks one or more consistency metrics, and compares the consistency metrics to predetermined boundary values. If a metric value exceeds a boundary value, updates are performed. The metrics can include numerical error, order error and staleness.

### BACKGROUND OF THE INVENTION

1. Field of the Invention

The present invention relates to network systems, and in particular to the update of replicated databases on a network.

2. Background of the Related Art

Network-based services are commonly used to provide services to users over a large geographic region. In many applications, it is not practical to use a single database for delivery of services across the entire network. Thus, there is a necessity for replicated databases to increase the speed or volume of transactions that can occur in a given time period. A local user is provided access to one of the replicas. Such replicated databases must periodically send updates between each other to maintain a level of consistency between all replica databases. Unfortunately, system performance may suffer due to the transactional overhead associated with maintaining consistency between replicated databases.

A variety of optimistic or relaxed consistency models have been proposed that provide improved performance and can tolerate relaxed consistency. However, such systems provide no bounds on the consistency of the data. Thus, in the current paradigm, system developers must choose between strong consistency with poor performance and optimistic consistency with improved performance, but uncertain or poor consistency.

### SUMMARY OF THE INVENTION

An object of the invention is to solve at least the above problems and/or disadvantages and to provide at least the advantages described hereinafter.

Another object of the invention is to provide metrics to manage a range of data consistency in an application.

Another object of the invention is to allow data consistency to be bounded on a per replica basis.

Another object of the invention is to provide metrics that are both generalized and practical for use in a wide range of applications.

In order to achieve at least the above objects in whole or in part, and in accordance with the purposes of the invention, as embodied and broadly described, a method and system embodying the present invention provides a selectable level of consistency by using metrics to control when data updates between replicated databases occur. In a data system having a plurality of data store replicas, a method embodying the invention includes the steps of receiving new data into a first replica, reading status data associated with at least one consistency metric relative to a second replica, comparing the status data to a predetermined consistency metric bound, and determining whether to update the replicas based on the result of the comparison step.

The metric that is compared to a boundary value could be a numerical error, an order error, or a staleness metric. Also, an embodiment of the invention could use one, two or all three of the metrics to control updates. Further, as will be explained below, the metric boundary values to which metrics are compared can be the same for all replicas, or each replica can have a different boundary value.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings, in which like reference numerals refer to like elements, and wherein:

FIG. 1 is a drawing illustrating the relationship between consistency, availability, and performance;

FIG. 2 is a graph illustrating different potential improvements in application performance versus the probability of inconsistent access, depending on workload/network characteristics;

FIG. 3 is a block diagram of an architecture for replicated services according to a preferred embodiment of the present invention;

FIG. 4 is a process flow diagram illustrating replication of data between data stores, according to a preferred embodiment of the present invention;

FIG. 5A is a block diagram illustrating features of first and second replicas or a replicated database system, according to a preferred embodiment of the present invention;

FIG. 5B is an illustration of the format of a write entry received at a replica;

FIG. 6 is a process flow diagram illustrating a process for making an update decision based on numerical error, according to a preferred embodiment of the present invention;

FIG. 7 is a data flow diagram illustrating a sequence of data flows for the process of FIG. 6, according to a preferred embodiment of the present invention;

FIG. 8 is a process flow diagram illustrating a process for updating data between replicas in accordance with an order error metric, according to a preferred embodiment of the present invention; and

FIG. 9 is a process flow diagram illustrating a process to determine whether updates should be made between replicas according to a staleness metric in a preferred embodiment of the present invention.

### DETAILED DESCRIPTION OF PREFERRED EMBODIMENTS

The present invention recognizes that there may be a continuum between strong and optimistic consistency that is semantically meaningful for a broad range of network services. This continuum is parameterized by the maximum distance between one replica's local data image and some final image that is “consistent” across all replicas after all writes have been applied everywhere. For strong consistency, this maximum distance is zero, while for optimistic consistency, it is infinite. The present invention is directed to the semantic space in between these two extremes.

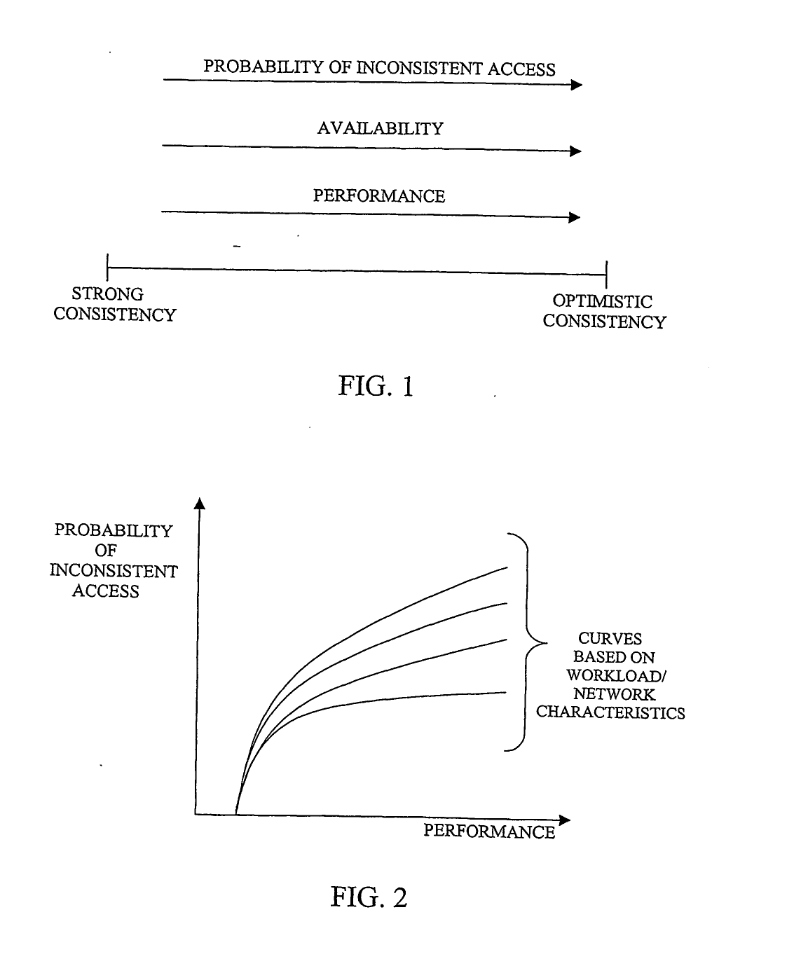

FIG. 1 is a drawing illustrating the relationship between consistency, availability, and performance. In moving from strong consistency to optimistic consistency, application performance and availability increases. This benefit comes at the expense of an increasing probability that individual accesses will return inconsistent results, e.g., stale/dirty reads, or conflicting writes. In the present invention, applications may be bound to a maximum probability/degree of inconsistency in exchange for increased performance and availability.

FIG. 2 is a graph illustrating different potential improvements in application performance versus the probability of inconsistent access, depending on workload/network characteristics. Moving to the right in the figure corresponds to increased performance, while moving up in the figure corresponds to increased inconsistency. To achieve increased performance, applications must tolerate a corresponding increase in inconsistent accesses. The tradeoff between performance and consistency depends upon a number of factors, including application workload, such as read/write ratios, probability of simultaneous writes, etc., and network characteristics such as latency, bandwidth, and error rates. At a point of high performance, large performance increases are available in exchange for a relatively small increase in inconsistency for applications represented by the bottom curve.

The invention is directed to methods and systems for controlling the consistency of data replicas in a system with two or more replicas, or copies, of the same database. The invention assumes that different users will access different data replicas and attempt to write or change the data in the replica they access. The invention also assumes that the replicas must update each other from time to time to ensure that a change recorded at a first replica is ultimately reflected in the other replicas in the system.

If a replicated database system allows some degree of inconsistency between the replicas, there is a chance that a data change received at a first replica will conflict with a data change received at a second replica. There is also a chance that a user accessing a first replica will read data in the first replica that is incorrect, because the first replica has not received data changes that were received at a second replica. Thus, the user accessing the first replica may make decisions based on incorrect data. These types of problems get worse as there is a greater level of inconsistency between the replicas. When these types of problems occur, it may be necessary to reverse entries received at one replica to accommodate changes made at a different replica. There are many known methods for resolving conflicts between replicated data systems.

On the other hand, if a replicated data system requires a high degree of consistency between replicas, the overhead required to continuously update each of the replicas based on the changes received at other replicas can degrade the performance and availability of the system. This is also undesirable.

The invention provides a way to selectively vary the required consistency between data replicas so that a system designer or administrator can dynamically tune the system to provide an optimal level of performance. In a system or method embodying the invention, a system designer or administrator can set consistency metric bounds that control the consistency between data replicas. The metric bounds can be adjusted from time to time to vary the required consistency, thereby also altering the performance of the system. The consistency metrics are flexible enough that they can be used in a wide range of different applications that utilize replicated databases. Instead of choosing between high consistency with poor performance or low consistency and good performance, a system administrator can periodically adjust the consistency metrics for a system to achieve a desired level of consistency and performance.

Furthermore, the metrics can be individually specified for individual replicas. For instance, the metrics for a three replica system can be set to provide easier/faster access to one of the replicas than to other replicas. Also, the metrics could be set such that users directed to one of the three replicas have a greater assurance that their transactions will not be canceled on the future because they conflicted with transactions recorded by a different user in a different replica.

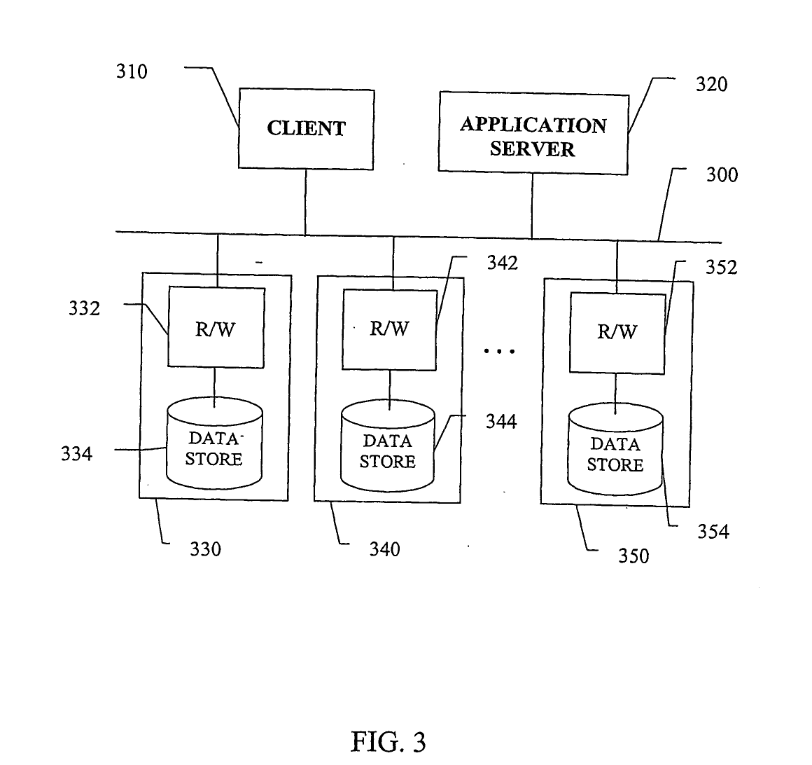

FIG. 3 is a block diagram of an architecture for replicated services, according to a preferred embodiment of the present invention. The architecture preferably includes a network 300, a client workstation 310, an application server 320 and first, second and third data replicas 330, 340 and 350. In other embodiments, there may be multiple networks 300, client workstations 310 or application servers 320. At least two replicas may be included. The architecture may exist in local, national, global or other regional settings.

The network 300 may be, include or interface to any one of, a personal area network (PAN), a local area network (LAN), a wide area network (WAN), an intranet, the Internet, a digital T1 or T3 line, a digital subscriber line (DSL) connection, an ethernet connection, an integrated services application digital network (ISDN) line, a cable modem, an asynchronous transfer mode (ATM connection, or other wired or wireless communications link.

The client workstation 310 may be or include, for instance, a personal computer (PC), a laptop computer, a personal data assistant (PDA), a browser-equipped cellular telephone or other TCP/IP client or other device. The client workstation 310 may include the Microsoft Windows™, Windows XP, NT, or 2000, UNIX, LINUX, MAC OS or other operating system or platform. The client workstation 310 may also include a microprocessor, a RISC processor, a micro controller or other general or special purpose device configured to provide control according to a set of instructions. The client workstation 310 may further include random access memory, electronically programmable read only memory, a hard drive, a CD ROM, or other storage device.

The application server 320 may be or include, for instance, a computer or other workstation running Microsoft Windows™, Windows 2000, Windows XP, UNIX, LINUX or other operating system or platform. The application server 320 may include application software for network-based services such as a bulletin board service (BBS), an airline reservation system, e-commerce services, or other distributed application.

The replicas 330, 340 and 350 may include read/write middleware 332, 342 and 352, respectively. The replicas 330, 340 and 350 may also include data stores 334, 344 and 354, respectively. The read/write middleware 332, 342 and 352 may control the receipt of new data from the client 310 or the application server 320. The read/write middleware 332, 342 and 352 may also control the propagation of data between the data stores 334, 344 and 354 as updates are required. The data stores 334, 344 and 354 may be or include, for instance, volatile or non-volatile memory in the form of integrated circuits, hard drives, tapes, CD ROMS, optical disks or other electronic storage media.

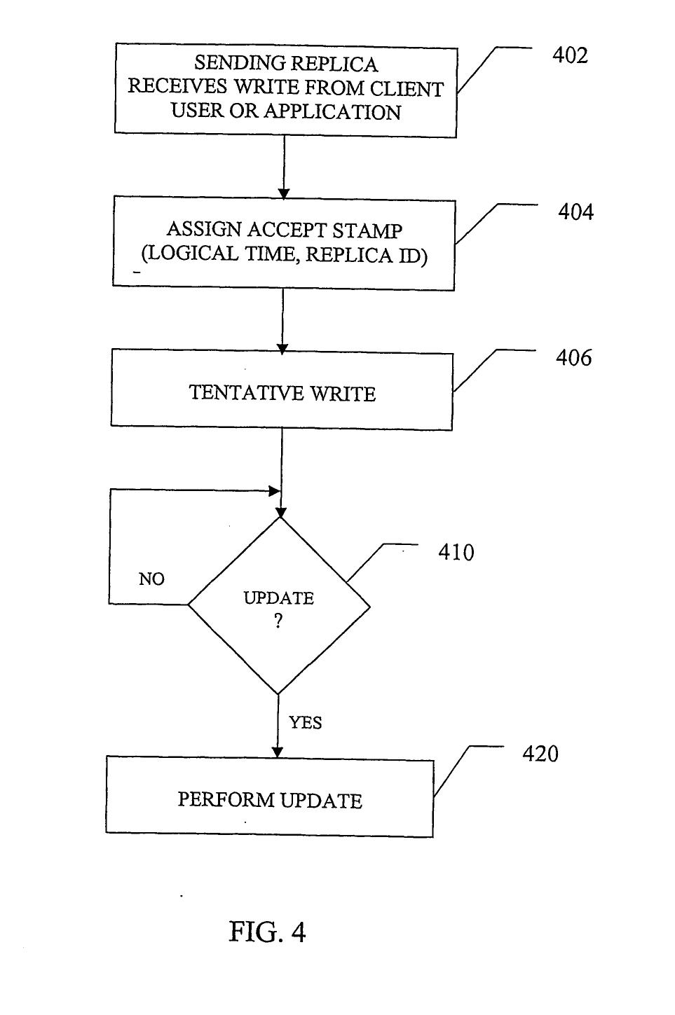

FIG. 4 is a process flow diagram illustrating a process for interacting with a replicated data system, and for replicating data between data stores, according to a preferred embodiment of the present invention. In step 402, write data is received from a client 310 or an application server 320. In step 404, the system assigns an acceptance stamp to the received data. A tentative write is then made in step 406.

The acceptance stamp assigned in step 404 preferably includes a logical time and an identification number of the replica receiving the data from the client 310 or the application server 320 and assigning the stamp. In some embodiments, this method may further include a step (not shown) for selectively converting writes from tentative to committed status, according to the sequence that data was originally received.

After a tentative write is performed, a decision step 410 is preferably made to determine whether data should be exchanged between replicas. In some embodiments, this could mean deciding (at a first replica) whether the data received at the first replica should be sent to a second replica. In another embodiment, step 410 may comprise determining whether data received at a second replica should be applied in the first replica. If the decision is in the affirmative, an update is preferably performed in step 420.

Generally speaking, entropy is a measure of disorder, unavailability, or uncertainty. Anti-entropy as applied to replicated databases refers to the process of sharing data between replicas to provide order, availability of data, and improved consistency of the data between replicas. In the related art, replicas may update other replicas at any time through voluntary anti-entropy. By contrast, in embodiments of the present invention, metrics are used to determine when compulsory anti-entropy sessions should occur according to the logic of decision step 410 to ensure correctness of the data.

The metrics used in decision step 410 could include one or more of numerical error, order error and staleness. Numerical error limits the total weight of tentative writes that can be accepted by all replicas in a system before a tentative write is propagated to a given replica. Order error limits the number of tentative writes (subject to reordering) that can be outstanding at any one replica. Staleness places a real time bound on the delay of write propagation among replicas.

In the present model, applications specify their application-specific consistency semantics using conits. A conit is a physical or logical unit of consistency, which is defined on an application by application basis. For example, in an airline reservation system, individual flights can be defined as a conit Alternatively, blocks of seats on a flight, for example first class seats or coach seats, may be defined as a conit. The use of conits advantageously provides a parameter that can be generalized and practically used in a wide range of applications.

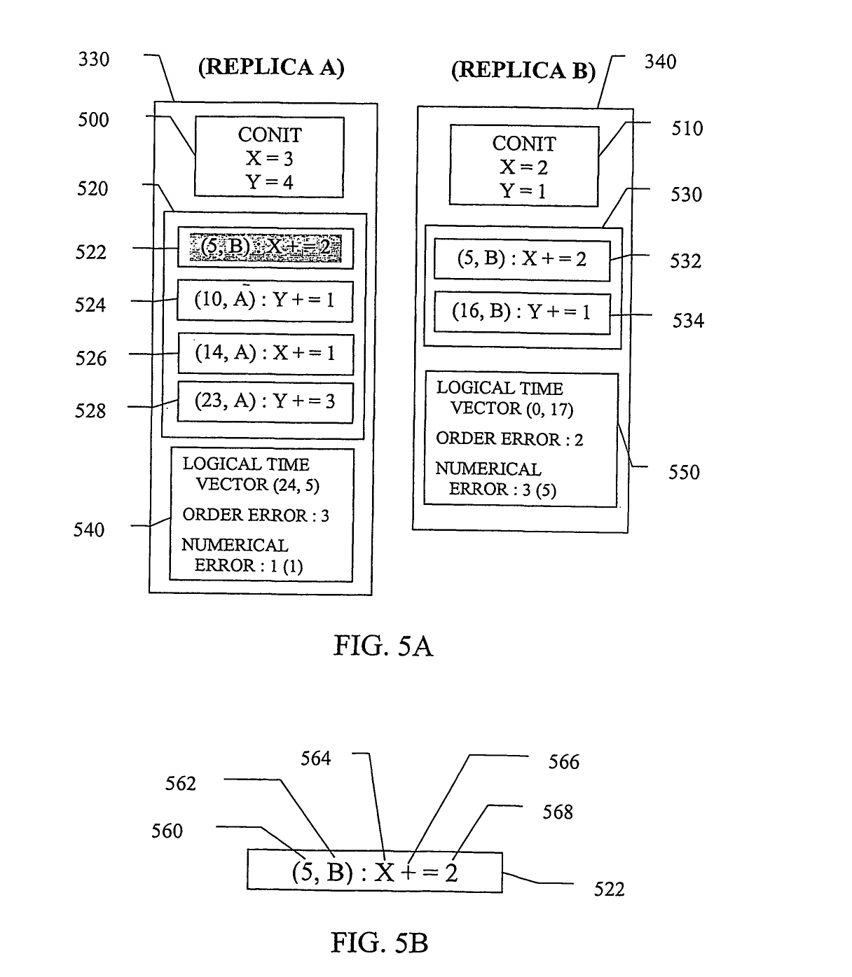

Examples of systems and methods embodying the invention will now be described with reference to FIGS. 5A, 5B and 6-9. In the following examples, an airline reservation system using replicated data is used for discussion purposes. It is to be understood that the invention is applicable to virtually any replicated data system. The airline reservation system is simply used as a convenient and familiar example.

The system and method of the present invention are applicable to any network with two or mote replicated databases. FIG. 5A is a block diagram illustrating a two replica airline reservation system that includes Replica A and Replica B. The Replicas A 330 and B 340 preferably include conit information 500 and 510, write logs 520 and 530 and logical parameters 540 and 550, respectively.

Conit information 500 and 510 may include two parameters x and y, where x is the number of seats reserved for first class passengers on an airplane and y is the number of seats reserved for coach passengers on an airline. The conit information could represent other parameters. For instance, x could be the number of aisle seats on a flight, with y representing the number of window seats. The write log 520 of Replica A includes entries 522, 524, 526 and 528, each of which represents a reservation made by a user for one or more seats on a given flight. The write log 530 of Replica B includes entries 532 and 534, which also represent reservations made by users for the same flight. Each entry in the write logs 520 and 530 preferably has the format illustrated in FIG. 5B.

FIG. 5B shows that entry 522 may include an acceptance stamp that includes a logical clock time 560 having a value of “5,” and the identity of the replica 562 that first received the write (reservation) from an end user. The entry 522 also includes a conit indication 564, an increment or decrement indicator 566 and a weight or other value 568. Thus, entry 522 indicates a reservation that was originally received at a logical clock time of 5 by Replica B for conit x (first class seats), and that the value of conit x should be increased by 2.

In the airline reservation system example shown in FIG. 5A, various reservations have been made by users. The meaning of the reservation entries, and a discussion of how data is shared/updated between the replicas will now be provided with reference to FIG. 5A.

The write log 520 for Replica A includes four entries. Entry 522 is a “committed” entry, whereas entries 524, 526 and 528 are “tentative” entries in the write log 520. The write log 530 in Replica B has two entries, both of which are “tentative” entries. As shown in FIG. 5A, only one data item is common between Replica A and Replica B.

To facilitate update decisions, Replicas A and B may further include logical information 540 and 550. Logical information 540 and 550 may include, for example, a logical time vector, an order error metric value, and a numerical error metric value. The logical time vector may include information related to synchronization between Replicas A and B.

For example, in logical information 540, a logical time vector of (24,5) may represent a current logical time in Replica A 330 of 24, and may further indicate that the most recent update received from Replica B 340 was received at a logical time of 5. Order error in logical information 540 preferably represents the number of tentative entries in write log 520. Thus, for Replica A, the order error is 3.

The numerical error of logical information 540 may be in the format of 1 (1) where the first number indicates the quantity of updates seen by Replica B that have not yet been seen by Replica A. The second number indicates the weight or value of the updates not seen by Replica A. For example, Replica A has not seen write entry 534 in Replica B's write log 530, which was received at a logical time of 16, and which has a y conit value of 1. Thus, the numerical error of Replica A relative to Replica B may be expressed as 1 (1). A discussion of how logical information 540 and 550 may be used in making update decisions 410 will be discussed below.

The logical information 550 in Replica B includes an order error of 2, which indicates that there are two tentative writes in the write log 530 of Replica B. The numerical error in Replica B is 3(5), which indicates that there are three writes in Replica A that have not been seen by Replica B, and that the total weight of the unseen writes is 5. Note that each of the writes potentially has a different weight.

In a system embodying the invention, the consistency bounds are enforced by having each replica check to see if it can accept a new reservation request without violating a predetermined limit on one of the consistency metrics. If accepting a new reservation would cause the local replica to exceed a predetermined limit on one of the consistency metrics, some type of anti-entropy session is performed so that data is exchanged between the replicas, and so that some or all tentative writes become committed writes. Once the anti-entropy session has been performed, the local replica will be free to accept a new reservation without violating the bounds on the consistency metrics.

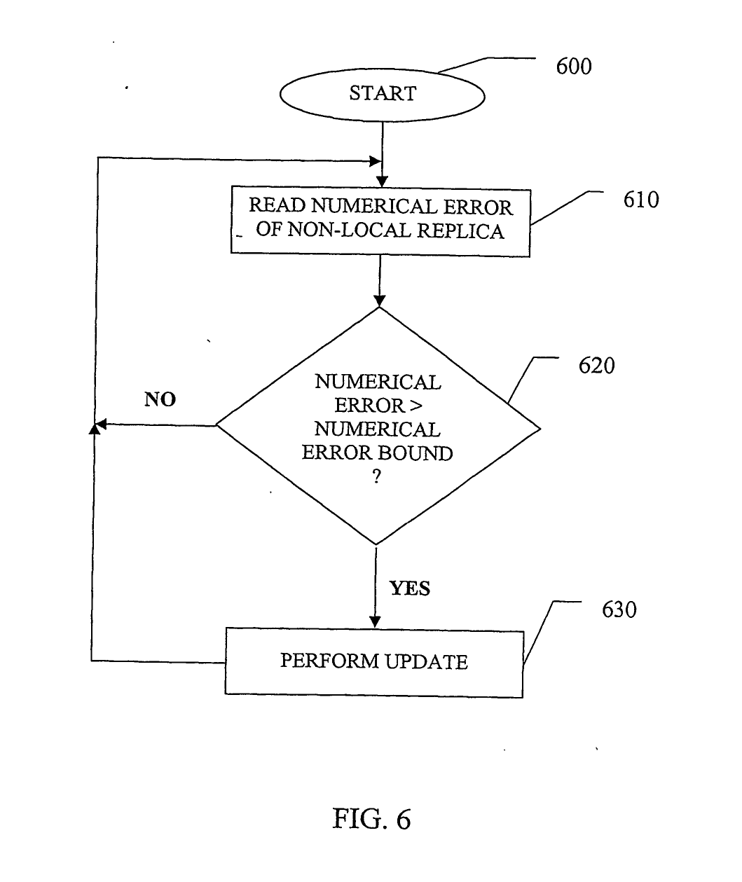

FIG. 6 is a process flow diagram illustrating a process for making an update decision based on the numerical error metric according to a preferred embodiment of the present invention. This process assumes that a local replica, Replica A, has received a request to reserve a seat on an airline from a user. After accepting the reservation, Replica A must now decide whether it is violating a predetermined bound on the numerical error metric.

Each replica is responsible for contacting all remote replicas to determine their numerical error value. Recall that numerical error is the total number of writes, and their associated weight, that exist at all remote replicas and that are unseen by a given local replica. Each replica preferably divides the numerical error range by n-1, where n is total number of system replicas. Such n-1 values are then stored in local storage, and may be called numErrorRangeRelX (numerical error range relative to replica X), for example, where X is the identifier of a given remote replica. Thus, after starting in step 600, a local replica preferably reads the numErrorRangeRelX of all non-local replicas in step 610.

Using the system illustrated in FIG. 5B, assume that Replica A had just received a reservation request from a user corresponding to write entry 528, which represents a request to reserve 3 coach class seats. Replica A would first determine the numerical error of each non-local replica in the system relative to itself. In this example, that would mean that Replica A would read the numerical error of Replica B relative Replica A. As illustrated in FIG. 5A, the numerical error of Replica B relative to Replica A is 3(5), which means Replica A has three tentative writes, with a total weight of 5, which have not been seen by Replica B.

Then, in step 620, the local replica determines whether the value of the numerical error metrics of each of the non-local replicas exceeds a predetermined numerical error bound. If the numerical error for one of the non-local replicas exceeds the numerical error bound, the local replica may push data updates to the non-local replica in step 630. In one embodiment, the local replica may push all data to the non-local replica. In another embodiment, the local replica may push data one at a time, for example starting with updates having the largest weights or value for conit data. Alternatively, the local replica could push writes to the non-local replicas based on the order in which they were received.

Again, with reference to the example in FIG. 5A, the step of comparing the numerical error of Replica B to the numerical error bound would comprise comparing the numerical error of 3(5) to a predetermined upper limit for numerical error. If the upper limit for numerical error were 3, this would mean that the numerical error bound is violated after Replica A receives the reservation request corresponding to write entry 528.

To avoid violating the numerical error bound, Replica A would push one or more of its tentative writes to Replica B, so that the numerical error bound is not violated. If Replicas A and B are the only replicas in the system, the anti-entropy session where Replica A pushes data to Replica B would probably result in the pushed data entries becoming committed entries in each replica.

Note, the numerical error bound must be compared to a numerical error value for each replica in the system. In other words in performing step 620 of FIG. 6, a replica must compare the numerical error of each non-local replica to a numerical error bound before determining whether the numerical error metric has been violated.

In a system embodying the invention, the numerical error bound can be the same for all replicas, or each replica may have a different numerical error bound. For instance, in a system having Replicas A, B and C, the numerical error bound for Replica B might be 3, while the numerical error bound for Replica C is 2. This means that when Replica A receives a new reservation request, Replica A may compare the numerical error of Replica B, relative to Replica A, to the bound of 3, and Replica A may compare the numerical error of Replica C, relative to Replica A, to the bound of 2 (assuming, for instance, that these values are the numerical error range assigned to replica A as stored in the numErrorRangeRelX variables described above).

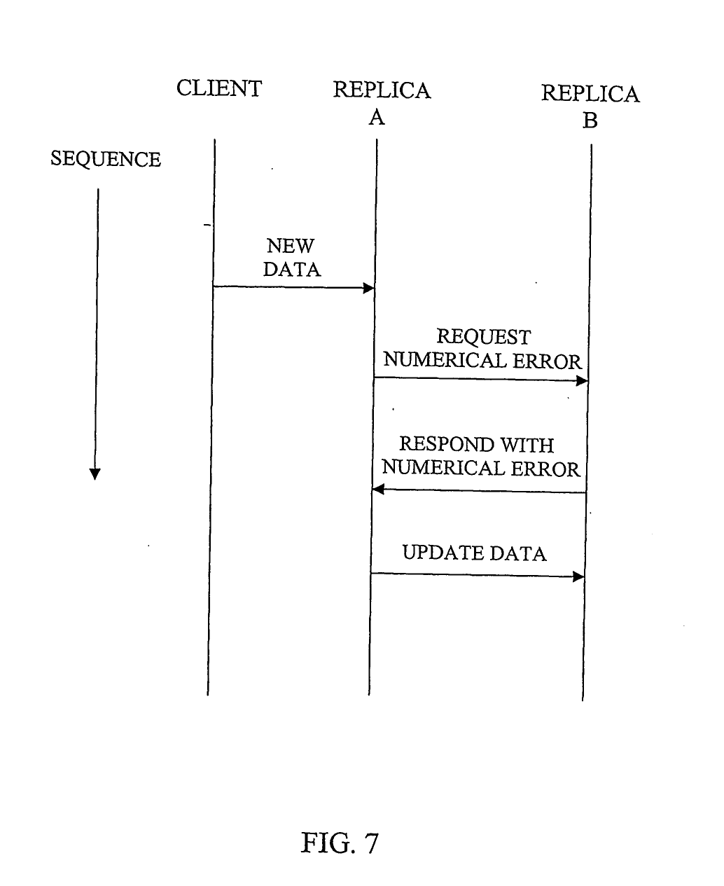

FIG. 7 is a data flow diagram illustrating a sequence of data flows for the process of FIG. 6, according to a preferred embodiment of the present invention. FIG. 7 shows the data flows between a client workstation, a first replica A and a second replica B. According to the sequence shown therein, a client workstation 310 may send a new data item to Replica A. Replica A would send a request message to Replica B for numerical error data, and Replica B may respond with numerical error data back to Replica A. Replica A may then perform decision step 620. If the numerical error bound for Replica B is violated, Replica A would push updated data to Replica B.

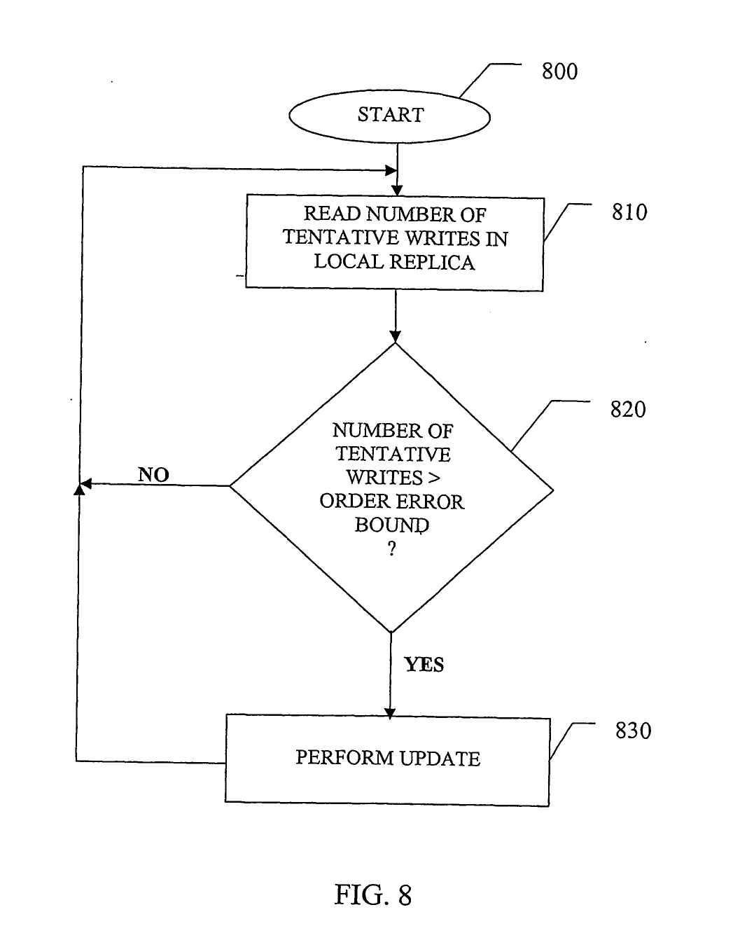

FIG. 8 is a process flow diagram illustrating a process for checking an order error metric, according to a preferred embodiment of the present invention. Again, we assume that a replica has received a new reservation request, and the local replica must now determine whether the new request will result in a violation of the bound on the order error metric. Recall that order error represents the number of tentative writes in the local replica that are unseen by other replicas.

After starting in step 800, a local replica preferably reads the number of tentative writes in the local replica's write log in step 810. In step 820, the local replica preferably determines whether the number of tentative writes is greater than an order error bound. If the number of tentative writes exceeds the order error bound, then the local replica performs an anti-entropy session to exchange data with other replicas. Advantageously, execution of the order error process described above does not require communication with other replicas to make the decision as to whether updates are necessary.

For example, with reference to FIG. 5A, step 810 of the method illustrated in FIG. 8 may comprise having Replica A read its own order error, which is 3, representing the number of tentative writes in write log 520. If the order error bound of Replica A is 2, then the bound would be exceeded. This would cause Replica A to conduct anti-entropy sessions with Replica B in order to convert one or more of the tentative writes into committed writes. As a result, the number of tentative writes at Replica A would be reduced, which would allow Replica A to accept new reservations without violating the order error bound.

Note, as with the numerical error bounds, each replica can also have its own individual order error bound. In other words, Replica A could have an error bound of 3, while Replica B has an order error bound of 2.

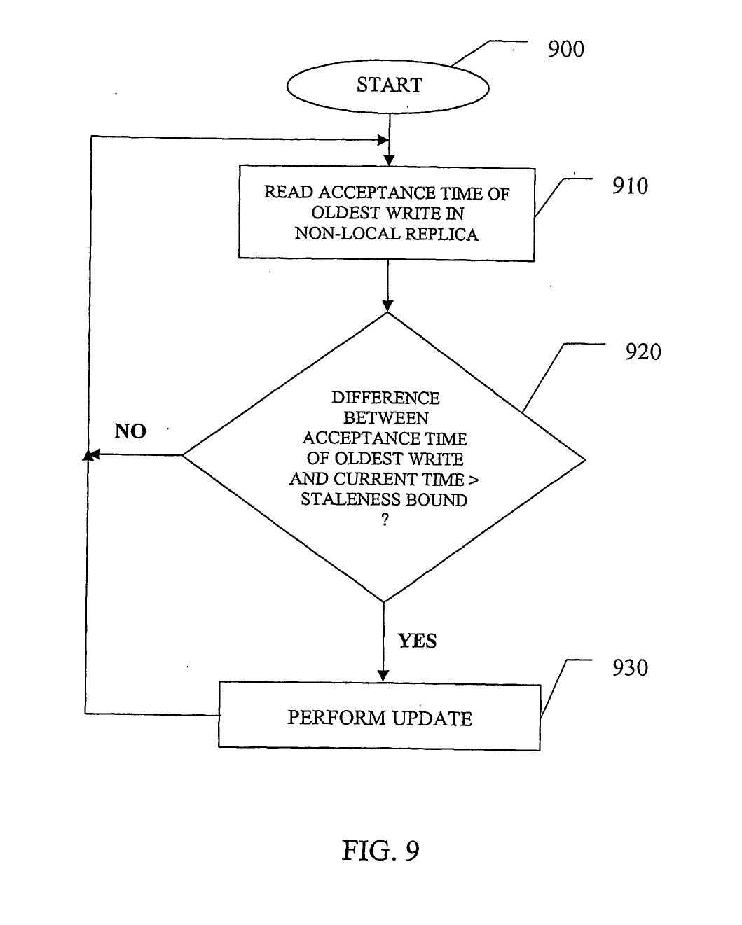

FIG. 9 is a process flow diagram illustrating a process to determine whether updates should be made between replicas according to a staleness metric in a preferred embodiment of the present invention. The staleness metric is a real time based metric that limits that maximum delay period that can elapse before a local replica receives updates from non-local replicas. A local preferably determines how long it has been since it last saw an update from each non-local replica. If the delay period exceeds a predetermined staleness bound, the local replica will perform anti-entry sessions to pull data from the non-local replicas.

In order to perform a check on the staleness metric, a local replica will use the committed writes in its write log that came from other non-local replicas to determine how long it has been since the local replica received an update from a non-local replica. For instance, with reference to the example shown in FIG. 5A, Replica A has one committed write in its write log that came from Replica B. Replica A will track an actual real time vector. Replica A will also have some way of determining how a logical time vector from a non-local replica corresponds to its own real time vector. Thus, Replica A will be able to determine the real time corresponding to logical time “5” at Replica B.

Because Replica A has a committed write from Replica B which was received by Replica B at logical time 5 (in Replica B's logical time scheme), Replica A knows that it has seen all writes received by Replica B up to at least logical time 5 (in the logical time scheme at Replica B). Replica A then converts logical time 5 from Replica B into its own real time vector. Lets call the time in Replica A's real time vector corresponding to logical time 5 in Replica B to be time t₁. Now Replica A knows that is has seen all writes received at Replica B up to real time t₁.

Replica A can then subtract t₁ from the current real time to determine the delay period that has elapsed since Replica B received the write that is committed in Replica A's write log. If this delay period exceed a staleness metric value, then Replica A can perform an anti-entropy session with Replica B to pull in more recent writes from Replica B.

A method of using staleness to determine when to pull updates from other non-local replicas will now be described with reference to FIG. 9.

After starting in step 910, a local replica preferably reads the acceptance time of the most recent write received by a non-local replica and stored in the local replica. In step 920, the local replica preferably determines whether the difference between an acceptance time of the most recent write from a non-local replica and the current time of the local replica is greater than a staleness bound. If the time difference is greater than a staleness bound, then the local replica preferably pulls updates from the non-local replica in step 930.

For example, with reference to FIG. 5A, step 910 would involve Replica A looking in its write log to locate the most recent committed write from Replica B. Replica A would find write entry 522, which was received at logical time 5. Step 920 of the method in FIG. 9 would involve determining the delay period that has elapsed between the present time, and the time when Replica B received the write entry. This would require converting logical time “538 in Replica B's logical time scheme into an actual time in Replica A's real time vector. Replica A would then subtract that time from the current time to determine the delay period. The delay period would then be compared to a staleness bound. If the staleness bound was exceeded, in step 930 Replica A would pull more recent writes from Replica B.

Note, as with the numerical error metric, the staleness metric is measured as between the local replica and one non-local replica in this example. Thus, a different staleness bound can be specified for each non-local replica. In other words, if a system includes Replicas A, B and C, then a first staleness bound can be set for Replica A to Replica B, and a second different staleness bound can be set for Replica A to Replica C.

Different embodiments of the present invention may use any one of, or any combination of, numerical error, order error and staleness to determine when updates are to be made between replicas in a network.

The consistency model described above can be applied to a wide range of different applications. For example, as described above, the system and method can be applied to an airline reservation system, where conits are used for the number of available seats on a given flight, and where the system can limit the rate of reservation conflicts by bounding relative numerical error, order error and staleness.

The invention is also applicable to a wide range of dynamic content distribution systems. For example, many modern web services produce much of the content dynamically, based on database state. In these applications, consistency is a key hurdle to replicating dynamic services across the network. The invention addresses this problem by planning application specific semantics to allow services to relax from strong consistency under certain circumstances according to the bounds that are established. For example, conits may be used to limit discrepancies in inventory in e-commerce services or the error in stock quotes provided by financial services.

The invention is also applicable to shared editors or other wide area corroborative applications. For example, in a shared editor, multiple authors work on the same document simultaneously. Consistency requirements include the amount of modification from remote authors not seen by a user and the instability of the current version due to uncommitted modifications. In such an application, conits may be defined on a per page, per paragraph or per character basis. Likewise, the invention may be applicable to distributed virtual reality games, traffic monitoring systems or other abstract data types.

The preferred embodiment of the invention described herein provides many advantages. For example, numerical error, order error, and staleness can be used separately or combined to manage a range of data access between the extremes of strong and optimistic consistency. These same metrics allow data consistency to be bounded on a per replica basis for each conit. This may be advantageous, for example, where a data store with higher consistency is reserved for preferred customer transactions, and other data stores with lower consistency are provided for ordinary customers. Moreover, the application of conits provides a framework that is genetal enough to support a wide variety of applications, yet practical enough to provide a high degree of utility in any particular application.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. In a data system having a plurality of data store replicas, a method of updating at least one of the plurality of data store replicas, comprising:
receiving new data into a first replica;
reading status data associated with at least one consistency metric relative to a second replica;
comparing the status data to a predetermined consistency metric bound; and
determining whether to update replica data based on a result of the comparison step.

2. The method of claim 1, further comprising updating replica data if the result of the determining step indicates that an update is required.

3. The method of claim 2, wherein the updating step comprises conducting anti-entropy sessions between the replicas.

4. The method of claim 2, wherein the updating step comprises the first replica sending writes to the second replica.

5. The method of claim 2, wherein the updating step comprises the first replica pulling writes from the second replica.

6. The method of claim 1, wherein the receiving step comprises:
receiving a write from one of a client and an application;
assigning an acceptance stamp to the write; and
storing the write in a data store of the first replica.

7. The method of claim 6, further comprising assigning a tentative status to the write.

8. The method of claim 6, wherein the storing step comprises making an entry in a write log of the first replica.

9. The method of claim 6, wherein the acceptance stamp includes a time and a replica identifier.

10. The method of claim 9, wherein the time is a logical time.

11. The method of claim 1, wherein the reading step is performed by the first replica.

12. The method of claim 1, wherein the reading step comprises reading information from the second replica.

13. The method of claim 1, wherein the at least one consistency metric is at least one of numerical error, order error and staleness.

14. The method of claim 1, wherein the reading step comprises reading a numerical error of the second replica relative to the first replica, the numerical error indicating the number of writes present in the first replica that have not been seen by the second replica.

15. The method of claim 14, wherein the numerical error of the second replica relative to the first replica also comprises a total weight of the writes present in the first replica that have not been seen by the second replica.

16. The method of claim 1, wherein the reading step comprises reading an order error of the first replica, the order error comprising the number of writes in the first replica that have not been seen by other replicas.

17. The method of claim 16, wherein the order error also includes a total weight of the writes in the first replica that have not been seen by other replicas.

18. The method of claim 1, wherein the reading step comprises reading a staleness metric, wherein the staleness metric indicates a delay period between the present time and the time that the second replica received the most recent write present in a write log of the first replica.

19. In a data system having a plurality of data store replicas, a method of updating at least one of the plurality of data store replicas, comprising using at least one metric of data consistency to provide a selectable level of data consistency on a per data store replica basis.

20. A system for providing network-based services comprising:
an interface to a communications link;
a data source coupled to the communications link; and
a first and second replica coupled to the communication link, wherein the first and second replicas each include a read/write controller and a data store, and wherein the read/write controller is configured to receive new data from the data source into the data store, read status data associated with at least one consistency metric relative to another replica, compare the status data to a predetermined consistency metric bound, and determine whether to update another replica based on a result of the comparison step.

21. A computer readable medium having stored thereon a sequence of instructions which, when executed by a processor, cause the processor to perform a sequence of steps, comprising:
receiving new data into a first replica;
reading status data associated with at least one consistency metric relative to a second replica;
comparing the status data to a predetermined consistency metric bound; and
determining whether to update replica data based on a result of the comparison step.
